(19) United States
(12) Patent Application Publication
(10) Pub. No.: US 2008/0207368 A1
(43) Pub. Date: Aug. 28, 2008

(54) Plate-link chain

(75) Inventors: Marcus Junig, Buhl (DE); Anton Simonov, Buhl (DE); Olga Ispolatova, Buhl (DE); Michael Pichura, Buhl (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/069,175

(22) Filed: Feb. 7, 2008

Related U.S. Application Data
(60) Provisional application No. 60/900,183, filed on Feb. 8, 2007.

(51) Int. Cl. F16H 7/18; F16G 13/04

(52) U.S. Cl. 474/140; 474/215

(57) ABSTRACT

A toothed plate-link chain composed of a plurality of interconnected plates that form chain links. The chain links are hingedly interconnected to adjacent links by transversely-extending hinge pins. A least some of the links include outer guide plates having convexly-curved ends that are so configured that the ends of adjacent guide plates contact each other when the chain is at a predetermined limiting angle of deflection during a swing-back mode, which deflection direction is in a direction opposite to the direction of deflection of the chain as it passes around a toothed wheel. The limitation of chain deflection during a swing-back mode serves to limit the frequency and amplitude of strand oscillations and thereby reduces the noise that would otherwise result from strand oscillations.

### BACKGROUND OF THE INVENTION

1. Field of the Invention

The present invention relates to a plate-link chain, in particular a toothed plate-link chain composed of a plurality of plates that form chain links. The chain links are hingedly connected by hinge pins to adjacent chain links, where some of the chain links include at least one guide plate. The present invention also relates to the use of such a plate-link chain and to a guide plate for use in such a plate-link chain.

2. Description of the Related Art

A plate-link chain of a type including guide plates is known from German Patent Application No. DE 10 2005 062 313. With such plate-link chains, chain strand vibrations can arise through the action of forces that act on the chain links as the chain meshes with or exits from the toothed wheel of a toothed chain drive or the pulley of a CVT transmission. The impact of the tooth flanks in association with the polygon effect of the link chain excites the chain strand to vibration. The same result occurs with chains in a CVT transmission as a result of the contacts of the end faces of the rocker members with the pulleys.

Because of the meshing impulses of the tooth plates as they mesh with the sprocket teeth in a toothed chain drive, excitations can occur that have different frequencies or orders, depending upon the speed of rotation of the chain. Because of the tensile force within the chain strand it has an oscillation frequency, similar to an instrument string, and can be excited resonantly. Those mechanisms can have a negative effect on the acoustic behavior of such a drive. A variety of remedial measures for avoiding those unwanted effects on the acoustics of the drive are known from, for example guide rails or damping elements within the transmission. Such measures require additional structural space, however, and they increase cost. It is therefore also known to prevent the development of chain strand vibrations through measures within the chain.

It is known from U.S. Pat. No. 1,780,040, for example, to provide a tooth plate with a right-angle bend or flange on the outer edge of the plate. In addition, to limit swing-back of the plate-link chain it is known to design the rocker members and the receiving openings in the link plates for the rocker members so that unimpeded deflection relative to each other of two adjacent links in a first oscillation direction is possible, at least to a certain maximum wrap angle, but is limited in the swing-back direction to a comparatively small swing-back angle. That is usually achieved by preventing the rolling motion of rocker members rolling on each other in the swing-back direction.

The known measures for limiting the swing-back of a plate-link chain are complex and cost-intensive, or they increase the necessary structural space, for example in the case of a guide rail.

An object of the present invention is therefore to provide an effective and inexpensive means for limiting the swing-back of a plate-link chain.

### SUMMARY OF THE INVENTION

The object is achieved by a plate-link chain, in particular a toothed plate-link chain, made up of a plurality of plates that form chain links that are hingedly connected with hinge pins to adjacent links. Some of the links include at least one guide plate, wherein at least part of adjacent guide plates are so designed that they touch at a limiting angle during the deflection in the swing-back direction relative to each other of two adjacent guide plates, to thereby prevent further deflection in the swing-back direction. Preferably, the hinge joints include rocker members, with one rocker member of a hinge joint being connected to the plates of a chain link and two rocker members of adjacent links forming the hinge joint, wherein the rocker members, each with a roller profile, can roll or slide against each other. Preferably, at least part of the adjacent guide plates have shoulder regions turned toward each other, which touch each other at the limiting angle of the deflection angle of two adjacent guide plates in the swing-back direction. Preferably, the shoulder regions that face each other have convexly curved bulges that contact each other at the limiting angle of the deflection angle of two adjacent guide plates in the swing-back direction. Preferably all guide plates are designed alike, so that two adjacent guide plates contact each other at the limiting angle of the deflection in the swing-back direction, and thereby prevent further deflection in the swing-back direction.

Preferably, the limiting angle is less than or equal to 10. That prevents a swing-back even at a very small swing-back angle. Preferably, two adjacent guide plates have a clearance greater than or equal to 0.1 mm when the plate-link chain is extended. That ensures easy installation of the plates when assembling the plate-link chain. To keep the surface pressure between two touching plates low at the point of contact, the thickness of the guide plates is greater than or equal to 1 mm.

The object identified above is also achieved with a guide plate for a plate-link chain and having two openings to receive rocker members that are situated at attachment regions, where at least one attachment region has a shoulder zone with a convexly curved bulge. The object identified above is also achieved by the use of a plate link chain in accordance with the invention in a belt-driven transmission.

### BRIEF DESCRIPTION OF THE DRAWINGS

The structure, operation, and advantages of the present invention will become further apparent upon consideration of the following description, taken in conjunction with the accompanying drawings in which:

FIG. 1 is a top view of a portion of a known plate-link chain;

FIG. 2 is a side view of the known chain shown in FIG. 1 as viewed along the line A-A of FIG. 1;

FIG. 3 is side view of a guide link plate;

FIG. 4 is a side view of a portion of a plate-link chain with a guide link plate in accordance with an embodiment of the present invention with the chain extended in a straight strand;

FIG. 5 is a side view similar FIG. 4 showing the chain in an oscillation mode; and

FIG. 6 is a side view similar to FIG. 4 showing the chain in a swing-back mode.

### DESCRIPTION OF THE PREFERRED EMBODIMENTS

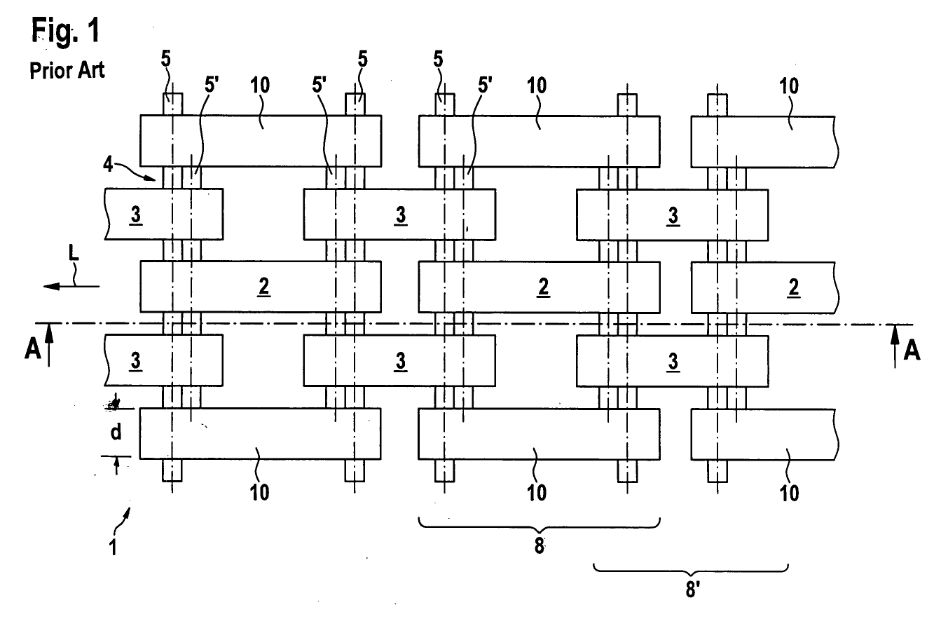

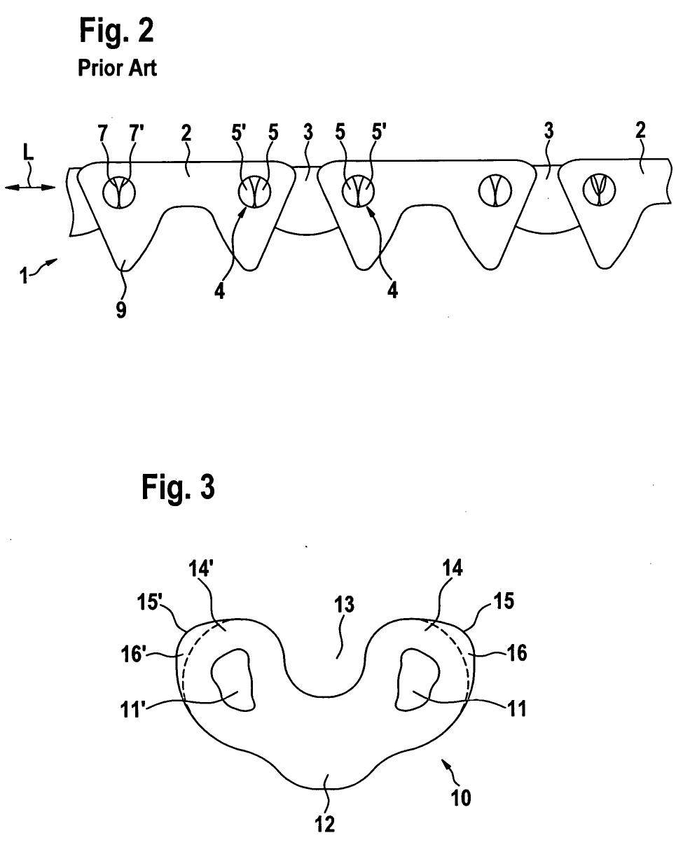

FIG. 1 is a top view of a known toothed plate-link chain 1 having a two-plate grouping. FIG. 2 is a side view of known plate-link chain 1 viewed in the direction of line A-A of FIG. 1. The basic construction of plate-link chains and the terms used in the exemplary embodiments in accordance with the present invention will be described on the basis of FIGS. 1 and 2. Although the exemplary embodiments of the present invention will be described using the example of a plate-link chain having two-plate groupings, those exemplary embodiments are equally applicable to a plate-link chain having three-plate groupings.

Plate-link chain 1 includes a large number of plates 2 and opposed plates 3. Plates 2 and opposed plates 3 are arranged alternately in a transverse direction of the chain, and are combined into a hinge joint with joint pins 4. Consequently, the ends of a plate 2 are hingedly connected by means of joint pins to one or two opposed plates 3 that overlap them, and, correspondingly, the ends of an opposed plate 3 are connected to one or two plates 2 with joint pins. The joint pins 4 can be a single pin, but preferably they are provided as pairs, with a rocker member 5 associated with each of the plates 2, 3 in a transverse direction and rolling against a contacting rocker member 5′ that is associated with an opposed plate 3.

Rocker members 5, 5′ of a rocker member pair each have respective facing and contacting rolling surfaces 7, 7′, with which they can roll against or slide on each other. The rolling surfaces 7, 7′ can be identically shaped or they can be of different shapes. The contour of the contact surface between rocker member 5 and plate 2 or between rocker member 5′ and the opposed plate is shown only schematically in FIG. 2 as of circular arc form. Instead of a circular arc contact surface, in the present invention contact surfaces are provided that correspond in shape with the shapes of the opposed endmost interior surfaces of openings 11 and 11′ as shown in FIG. 3.

The plates 2 and opposed plates 3 are stacked transversely relative to the chain running direction (identified in FIGS. 1 and 2 by an arrow labeled L), so that an overlapping opposed plate 3 is located between two plates 2 that are in side-by-side relationship when viewed in a direction perpendicular to the chain running direction L. Similarly, a plate 2 is located between and overlaps two opposed plates 3 that are in side-by-side relationship when viewed in a direction perpendicular to the chain running direction L. Of course, that relationship does not apply to the laterally outermost opposed plates 3—those opposed plates 3 have a neighboring plate 2 on only one side.

The sets or associated pairs of plates 2 arranged as shown in FIG. 1 form a chain link 8, and, correspondingly, the sets or associated pairs of opposed plates 3 form a chain link 8′. The plates 2 and the opposed plates 3 are each provided with plate teeth 9—as can be seen in FIG. 1. By means of the plate teeth 9, plate link chain 1 can mesh with a toothed component, for example a gear. The outermost plates at the chain links 8 are guide plates 10. FIG. 1 shows as an example chain link 8 as a set of three plates, a plate 2 and two guide plates 10, and chain link 8′ as a set of two opposed plates 3; but the chain links can also include plate sets with any other number of plates 2 and opposed plates 3. In the exemplary embodiment of the present invention the plates 2 and opposed plates 3 are identical parts; the only difference between plates 2 and opposed plates 3 is their arrangement within the plate-link chain. Both the plates 2 and the opposed plates 3 are therefore referred to in general as plates 2 or 3.

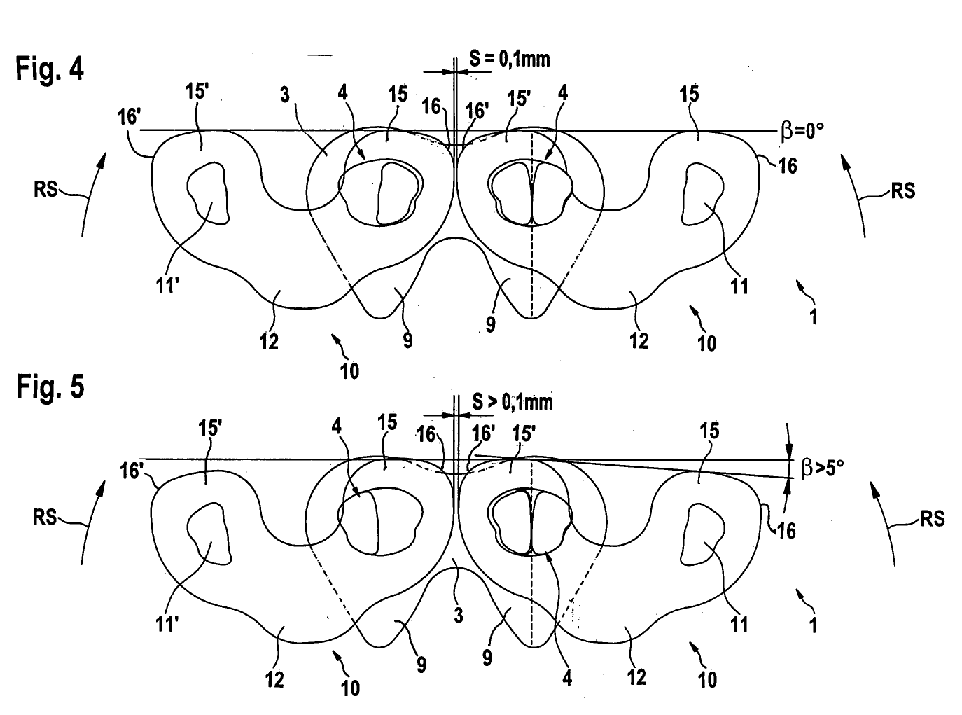

FIG. 3 shows a side view of a guide plate 10 that includes an opening 11 and an opening 11′, each having a shape adapted to receive a rocker member 5. Guide plate 10 has a lobe 12 at its lower edge, which engages the laterally outermost surfaces of the toothed wheel teeth of a toothed wheel as the plate-link chain passes around the toothed wheel, and it thereby provides for axial guidance of the toothed plate-link chain on the toothed wheel. When guide plate 10 is in the installed position in a plate-link chain 1, as shown in FIG. 4 for example, lobe 12 extends in the same direction as the link plate teeth 9 and partially overlaps them. On the opposite, upper edge of guide plate 10 that faces in the opposite direction of link plate teeth 9 when it is in the installed position, guide plate 10 includes an indentation 13, as shown in FIG. 3. The indentation 13 reduces the tensile stiffness of the guide plates 10 in the running direction L of plate-link chain 1, so that their tensile stiffness is not greater than that of the link plates 2 and of opposed plates 3.

Guide plate 10 includes laterally spaced attachment regions 14 and 14′, in which the openings 11 and 11′ are provided. The lobe 12 is situated between attachment regions 14 and 14′. The attachment regions 14 and 14′ each have shoulder regions 15 and 15′ that are the portions of the attachment regions 14′ that lie relatively close to the adjacent guide plates 10 in all possible bending positions of the plate-link chain. The contours of the shoulder regions 15 and 15′ for the known guide plate 10 are represented in FIG. 3 as dashed lines; the contours of the shoulder regions 15 and 15′ in accordance with the present invention are represented in FIG. 3 as solid lines. The latter contours, compared to the contours of the known guide plates, have more severely convex curvatures and thus provide convexly curved bulge regions 16 or 16′ relative to the contours of the known guide plates.

FIG. 4 shows two guide plates 10 in accordance with the present invention in a portion of a plate-link chain 1. The figure shows a link plate 3 with two joint pins 4, each of which includes a rocker member 5 and a rocker member 5′. The representation in FIG. 4 shows a straight strand of plate-link chain 1, i.e., with plate-link chain 1 extended, which is made clear by a straight line designated as β=0° connecting the top edges of the guide plates. Between the guide plates 10 there is a clearance (assembly clearance), which in this case is S=0.1 mm, for example.

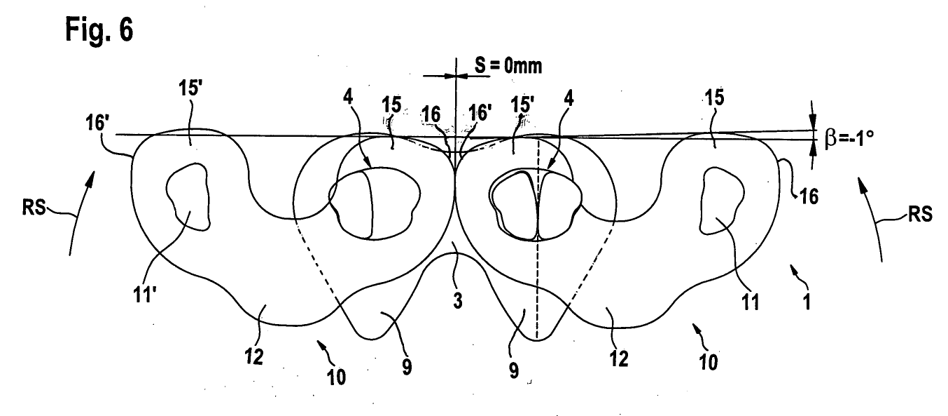

FIGS. 5 and 6 show deflections (bending) of the plate-link chain. FIG. 5 shows the chain in an initial oscillation mode and FIG. 6 shows the chain in a swing-back mode. An initial oscillation mode refers to the bending or deflection of the plate-link chain in the direction in which it loops around as an endless torque-transmitting means. A swing-back mode refers to a bending or deflection of the plate-link chain in the opposite direction, for example during a strand vibration. The swing-back direction is identified in FIGS. 4, 5, and 6 by an arrow RS. When the plate-link chain is extended, as in FIG. 4, adjacent guide plates 10 and hence the associated chain links 8 are not deflected relative to each other, and the angle of deflection β is therefore zero degrees. When there is a deflection in the initial oscillation direction as shown in FIG. 5, i.e., opposite to the direction indicated by the arrows RS, the angle β is considered to be positive as, for example at an angle β of about 5 degrees as shown in FIG. 5. In the swing-back mode shown in FIG. 6, i.e., when both chain links or two adjacent guide plates 10 are deflected in the swing-back direction RS, the angle of deflection β is considered to be negative, shown in FIG. 6 as a swing-back angle of β=−1°.

The shoulder regions 15 of the guide plates 10 include the convexly curved bulges 16 or 16′ corresponding to FIG. 3. The outer contours of the bulges 16 and 16′ are so designed that the clearance S between facing bulges of two adjacent, end-to-end, or shoulder region to shoulder region, arranged guide plates is reduced when the chain is in a swing-back mode, i.e., at an angle of chain deflection β<0°, compared to the clearance existing when the plate-link chain is longitudinally extended. At a limiting angle βₘₐₓ of the angle of deflection, the convexly curved bulges 16 and 16′ of two adjacent guide plates touch each other. As a result, further deflection of the chain in the swing-back direction RS is not possible. The limiting angle βₘₐₓ of the angle of deflection β is chosen as βₘₐₓ=−1° in the present exemplary embodiment. Other limiting angles βₘₐₓ can also be chosen, depending upon the requirements for the plate-link chain. The deflection of adjacent chain links in the initial oscillation direction (β>0°) is not obstructed or limited by the design of the shoulder regions of the guide plates 10 in accordance with the present invention, so that the looping of chain in the form of an endless torque transmitting means about a toothed wheel is unimpeded. The guide plates 10 have a thickness d, which is shown in FIG. 1 and which is greater than or equal to 1 mm.

As can be appreciated from viewing FIG. 5, because of the shapes of the shoulder regions 15, 15′ and the curvatures of the bulges 16, 16′ of guide plates 10, the clearance S between the opposed ends of adjacent guide plates 10 becomes larger when the chain is undergoing bending or deflection in the direction of an initial oscillation mode (β>0°). In a swing-back process, on the other hand, the clearance S becomes smaller until the shoulder regions 15 and 15′ of two adjacent guide plates 10 impact each other, when the clearance becomes zero. The impacting of the ends of adjacent guide plates 10 limits the bending of the plate-link chain in a swing-back direction to an angle of β=−1°, for example, as shown in FIG. 6.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A plate-link chain comprising: a plurality of link plates that form chain links that are interconnected with adjacent chain links by a hinge joint, wherein at least some of the chain links include at least one guide plate and wherein at least oppositely-facing end surfaces of adjacent guide plates are configured so that they contact each other when the chain is at a predetermined limiting angle of deflection of the chain when the chain is in a swing-back mode in a chain strand curvature direction that is opposite from a chain curvature direction of the chain as it passes around a driven wheel, so that further deflection of the chain in the swing-back direction is prevented to limit chain strand oscillation amplitude.

2. A plate-link chain in accordance with claim 1, wherein the hinge joints include rocker members and wherein one rocker member of a hinge joint is in contact with link plates of a first chain link, and two rocker members of chain links adjacent to the first chain link define the hinge joint, and wherein the rocker members each have respective rolling surface profiles that roll against each other.

3. A plate-link chain in accordance with claim 2, wherein least two of the adjacent guide plates have shoulder regions that face each other and that contact each other at the predetermined limiting angle of deflection of the chain when the chain is in the swing-back mode.

4. A plate-link chain in accordance with claim 3, wherein the shoulder regions that face each other have convexly curved bulges that contact each other at the predetermined limiting angle of deflection of the chain when it is in the swing-back mode.

5. A plate-link chain in accordance with claim 1, wherein the predetermined limiting angle of deflection is no greater than about 1° relative to a longitudinal line passing through the chain when it is in a straight, extended orientation.

6. A plate-link chain in accordance with claim 1, wherein end regions of two adjacent end-to-end arranged guide plates have a clearance therebetween that is at least 0.1 mm when the plate-link chain is in a straight, extended orientation.

7. A plate-link chain in accordance with claim 1, wherein the guide plates have a thickness of at least 1 mm.

8. A plate-link chain in accordance with claim 1, wherein the chain is a toothed plate-link chain

9. A guide plate for a plate-link chain, said guide plate comprising: a plate having two spaced openings at longitudinally spaced attachment regions adjacent longitudinal ends of the plate for receiving rocker members, wherein at least one attachment region includes a shoulder region having a convexly curved outward bulge for end-to-end contact with an adjacent guide plate to limit deflection in a swing-back mode of a chain containing guide plates to a predetermined deflection angle relative to a longitudinal line passing through the chain when it is in a straight, extended orientation.

10. An endless-belt-driven transmission including a plate-link chain in accordance with claim 1.
